(19) United States
(12) Patent Application Publication
(10) Pub. No.: US 2009/0229429 A1
(43) Pub. Date: Sep. 17, 2009

(54) Torque reducing and stabilizing screwdrivers and slotted threaded fasteners and related methods

(76) Inventor: Gary V. Heesch, Salt Lake City, UT (US)

Correspondence Address: Lynn G. Foster, 65 N Street, Suite C3, Salt Lake City, UT, 84103, US

(21) Appl. No.: 12/386,188

(22) Filed: Apr. 15, 2009

Related U.S. Application Data
(63) Continuation of application No. 11/999,455, filed on Dec. 5, 2007.

(51) Int. Cl. B25B 23/00

(52) U.S. Cl. 81/461; 411/403

(57) ABSTRACT

Novel screwdrivers used in combination with novel threaded fasteners are disclosed, both of which comprise male and female stabilizing segments which contiguously match male and female torque-applying segments which contiguously match.

### FIELD OF INVENTION

The present invention relates generally to screwdrivers combined with threaded fasteners and more particularly to such where the head of the driver and the head of the fastener comprise both matching. male/female stabilizing segments and matching male/female torque imposition segments, and related methods.

### BACKGROUND

Use of a screwdriver, manual or powered, to turn a threaded fastener, such as screws and bolts, is an odd art which-has largely been static for many years. It is sometimes difficult to have sufficient torque and turning stability to firmly and facilely set the fastener in place and/or facilely remove the fastener from a previous insertion site. Often the distal end of the screwdriver rides over and out of the screwdriver receiving head of the fastener, sometimes causing damage to the fastener, and/or injury to the user.

Provision of improved ways to reduce the torque demand and to stabilize the placement and removal of threaded fasteners with a screwdriver would be highly desirable.

### BRIEF SUMMARY AND OBJECTS OF THE INVENTION

In brief summary, the present invention overcomes or substantially alleviates prior torque and stability problems concerning placement and removal of threaded fasteners, such as screws and bolts, using a mechanical or a powered screwdriver.

It is a primary object of this invention to provide in combination novel screwdrivers and threaded fasteners, including screws and bolts, which require lower torque and provide improved stability during fastener rotation.

It is another paramount object of this invention to provide, in combination, a screwdriver with a distal driving end and a threaded fastener with a screwdriver receiving head, wherein both the screwdriver head and the fastener head comprising contiguously matching male/female stabilizing segments and contiguously matching male/female torque-applying segments whereby turning the fastener requires less torque and provides better stability.

Further objects of the invention will become evident in the description below.

### BRIEF SUMMARY OF THE DRAWINGS

FIGS. 1-9 illustrate in fragmentary broken away perspectives nine embodiments of the present invention;

FIG. 10 is a fragmentary cross section taken along lines 10-10 of FIG. 9;

FIGS. 11 and 12 illustrate in fragmentary broken away perspectives two additional embodiments of this invention;

FIG. 13 is a fragmentary cross section taken along lines 13-13 of FIG. 12; and

FIGS. 14 and 15 illustrate in fragmentary broken away perspectives two more embodiments of the present invention.

### DETAILED DESCRIPTION OF THE ILLUSTRATED EMBODIMENTS

Use of a screwdriver, manual or powered, to turn a threaded fastener, such as a screw or bolt, is an old art which has largely been static for many years. It is sometimes difficult to have sufficient torque and turning stability to firmly and facilely set the fastener in place and/or facilely remove the fastener from a previous insertion site. Once the distal end of the screwdriver rides over and out of a screwdriver placement site on the head of the fastener, damage to the fastener often occurs.

Provision of improved ways to reduce the torque demand and to stabilize the placement and removal of threaded fasteners with a screwdriver is the primary purpose of the present invention. Thus, in combination, the present invention provides a variety of screwdrivers, each with a distal driving end or blade and an associated fastener with a screwdriver-receiving site wherein both the screwdriver head and the fastener head, when combined to place or remove the fastener, comprise both contiguous matching male/female stabilizing segments and contiguously matching male/female torque-applying segments. Therefore the turning of the fastener, in each case, requires less torque and provides better stability between the screwdriver head and the fastener head.

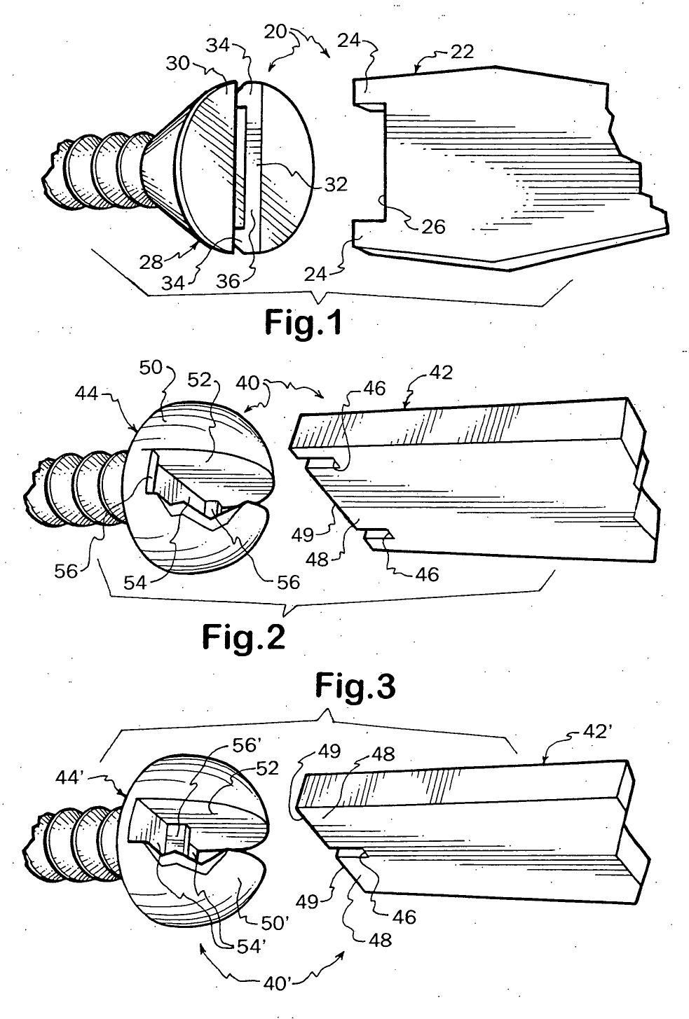

Reference is now made to the drawings wherein like numerals are used to designate like parts throughout. FIG. 1 illustrates a first embodiment comprising in combination, generally designated 20, a screwdriver distal end or blade 22 comprising opposed generally rectangular distal stabilizing projections 24 separated by an open slot 26, which applies torque. The combination 20 further comprises threaded fastener 28, such as a screw or bolt, which comprises a head 30 with a U-shaped slot 32 located, sized and shaped to contiguously receive the male projections 26 at locations 34 to create contiguous matching male/female stabilizers and to centrally receive the leading edge 26 at site 36 to provide contiguously matching male/female applying torque segments. Thus, less torque is required and improved stability provided for placement and removal of the fastener 28 in a desired location.

Reference is now made to FIG. 2 which illustrates a combination, generally designated 40, comprising a distal end or blade 42 of a screwdriver and a threaded fastener 44. The distal end 42 of the screwdriver comprises two spaced rectangular stabilizing slots 46 separated by a male torque-applying blade 48 comprising a distal edge 49. The threaded fastener 44 comprises a proximal rounded head 50 containing a slot 52. The fastener slot 52 is of essentially almost the same width as the blade 48 so that when blade 48 is inserted into the slot 52, the fit will be snug and edge 49 will bottom out contiguously on slot surface 54, with the sides of the blade 48 contiguous with the sides of the slot 52, when the screwdriver rotates the fastener. In this position the stabilizing slots 46 of the distal end 42 of the screwdriver are seated over male bars or flanges 56 in contiguous relation. Thus, the screwdriver head 42 and the fastener head 50 comprise structure in the nature of contiguous matching male/female stabilizing segments and contiguous matching male/female torque-applying segments for reducing the torque necessary to turn the fastener 44, at the same time, and provide improved stability between the fastener head and the screwdriver head.

Reference is now made to FIG. 3, which illustrates a combination 40′ comprising a screwdriver head, blade or distal end generally designated 42′ in combination with a threaded fastener, generally designated 44′ comprising a fastener head 50′. Screwdriver head or blade 42′ is very much like previously described screwdriver head 42, except only one slot 46 is provided along with two torque-applying blade ends 44, respectively flank on opposite sides the slot 46. The threaded fastener 44′ comprises slot 52 having base surface sections 54′ and a single central male stabilizing flange 56′ located at the center of the slot separating the two base surfaces 54′. The width of the slot 52 is nearly the same as the width of the blades 48 so, upon insertion and screwdriver rotation, the blade segments 48 will be contiguous with the side surfaces of the slot 52 and the central male stabilizer 56′ will fit snugly into the slot 46. Thus, screwdriver/fastener combination 40′ (FIG. 3) provides both a screwdriver head and a fastener head such that contiguously matching male/female stabilizing segments and contiguously matching male/female torque-applying segments are provided whereby less torque is required to turn the fastener and improved stability between the screwdriver and the fastener is obtained.

Reference is now made to FIG. 4, which illustrates a further combination, generally designated 60, comprising the distal end, blade or screwdriver head 62 and a threaded fastener generally designated 64. The combination 60 embodiment of FIG. 4 is substantially identical to the embodiment of FIG. 3, with the exception that the screwdriver blade comprises a central pointed male stabilizer 66 and the slot 52 of the head 50′ comprises a central tapered recess 68. The stabilizer 66 and recess 68 contiguously match when the screwdriver blade 62 is inserted into the slot 52. The operation and benefits of the combination embodiment 60 of FIG. 4 are the same as those described in conjunction with combination 40′ of FIG. 3.

The combination 70, illustrated in FIG. 5, is substantially similar to the combination 40 of FIG. 2, with the exception that the distal end of the screwdriver or screwdriver blade 42′ is tapered along each side edge at 72. Otherwise the combination 70 is the same as the combination 40 and is so enumerated. The operation and advantages of the embodiment of FIG. 5 are the same as those explained in respect to combination 40.

Reference is now made to FIG. 6, which illustrates a combination, generally designated 80, comprising the blade or distal end 62′ of a screwdriver and a threaded fastener 64′. The combination 80 is substantially like the previously described combination 60 of FIG. 4, with three exceptions, i.e. the central stabilizing projection 66′ is rectangular rather than pointed, the side edges of the screwdriver blade, at 72, are tapered and the head 50′ of the threaded fastener 64′ comprises a central rectangular slot 68′. Otherwise, the elements of the combination 80 are the same as the previously described elements of combination 60. These common elements are identified by the same numerals in both FIGS. 4 and 6. The operation and advantages of the combination 60 are the same as those described in conjunction with the previous embodiments as recited above.

FIG. 7 illustrates a further combination embodiment of the present invention, generally designated 90. Combination 90 comprises the distal or blade end of a screwdriver 92 comprising, at the extreme distal location, two stabilizing projections 94 and three spaced torque-applying portions 96, each ending in a blunt surface 49. The combination 90 also comprises a threaded fastener, generally designated 98. Threaded fastener 98 comprises a proximal fastener head 100 in which a radially directed slot 52 is formed. Slot 52 comprises a base surface having two spaced rectangular recesses or slots 102, located, sized and spaced so as to contiguously receive the male stabilizers 94, when the blade 92 of the screwdriver is inserted fully into the slot 52. Fastener 98 also comprises three spaced flat surfaces 104 positioned and sized so as to abut the edge surfaces 49 of the screwdriver blade 92, when the blade is fully inserted into the slot 52.

In operation, the blade 92 is inserted into the slot 52 so as to create a snug essentially contiguous relationship between the sides of the blades 92 and the sides of the slot 52. In this position, the stabilizing extensions 94 contiguously reside in the rectangular slots 102 and the surfaces 49 contiguously engage respectively the surfaces 104. Thus, in use during rotation, with the screwdriver blade 92 so inserted into the slot 52, the male/female stabilizing segments 94 and 102 contiguously match and the male/female torque-applying segments 96/49 contiguously match the side walls of the slot 52 and the surfaces 104 such that the turning of the fastener by the screwdriver requires less torque and provides better stability.

Reference is now made to FIG. 8, which illustrates a combination, generally designated 110, comprising a screwdriver blade or distal end 92′ and a threaded fastener 98′. Combination 110 is identical to the previously described combination 90 with two exceptions, i.e. the stabilizing projections 94′ are pointed and the stabilizing slots or recesses 102′ in the slot 52 of the threaded fastener 98′ are likewise tapered slots, which are sized and shaped to match and be contiguous with the pointed male stabilizing projections 94′ when the blade 92′ is fully inserted into the slot 52 of the threaded fastener 98′ and rotated. The other elements of the screwdriver blade 92′ and the threaded fastener 98′ are the same as described above in conjunction with combination 90 of FIG. 7 and are so enumerated in FIG. 8. The operation and benefits of the combination 110 are the same as those described above in conjunction with combination 90.

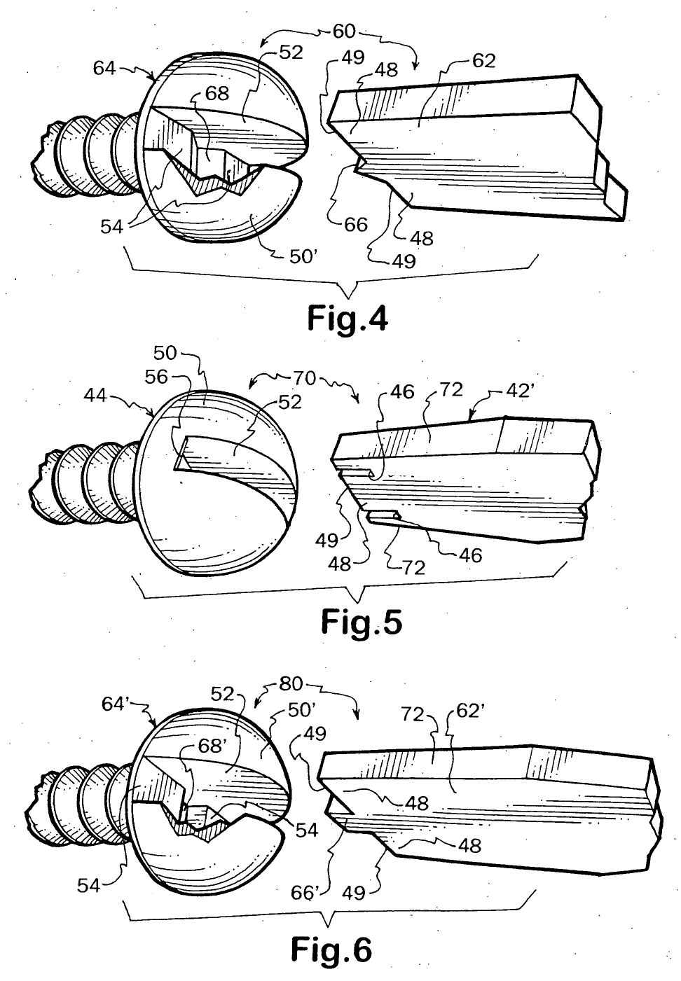

Reference is now made to FIG. 9, which shows a combination, generally designated 120 comprising the blade end of a phillips screwdriver 122 and a threaded fastener 124 having a flat head in the nature of a phillips head. The head 122 of the phillips screwdriver comprises four male torque-applying radially-extending segments 126, separated by cavities or recesses 128. The distal tip 130, shown best in FIG. 10, comprises a central stabilizing blind bore 132. The threaded phillips-type fastener 124 comprises star-shaped radially-directed recesses or grooves 134 located, sized and shaped so as to contiguously receive the torque-applying segments 126 of the distal end 122 of the phillips-type screwdriver during rotation. In addition, the threaded fastener 124 comprises a proximally-extending central cylindrical male stabilizing segment 136, located, sized and shaped so as to fit snugly and contiguously within the central blind bore 132 of the distal end 122 of the screwdriver.

Thus, when the distal end 122 of the screwdriver is connected to the fastener 124, the cylindrical stud 126 and the blind bore 132 contiguously match and stabilize the inserted relationship. The male torque-applying segments 126 rest contiguously in the fastener grooves 134. Thus, when fastener rotation occurs, less torque is required and improved stability provided by the male/female matching elements of the stabilizers and the torque-applying elements, in a manner explained in greater detail above. The male stud 136 can be part of the screwdriver head and the matching blind bore 132 part of the threaded fastener 124.

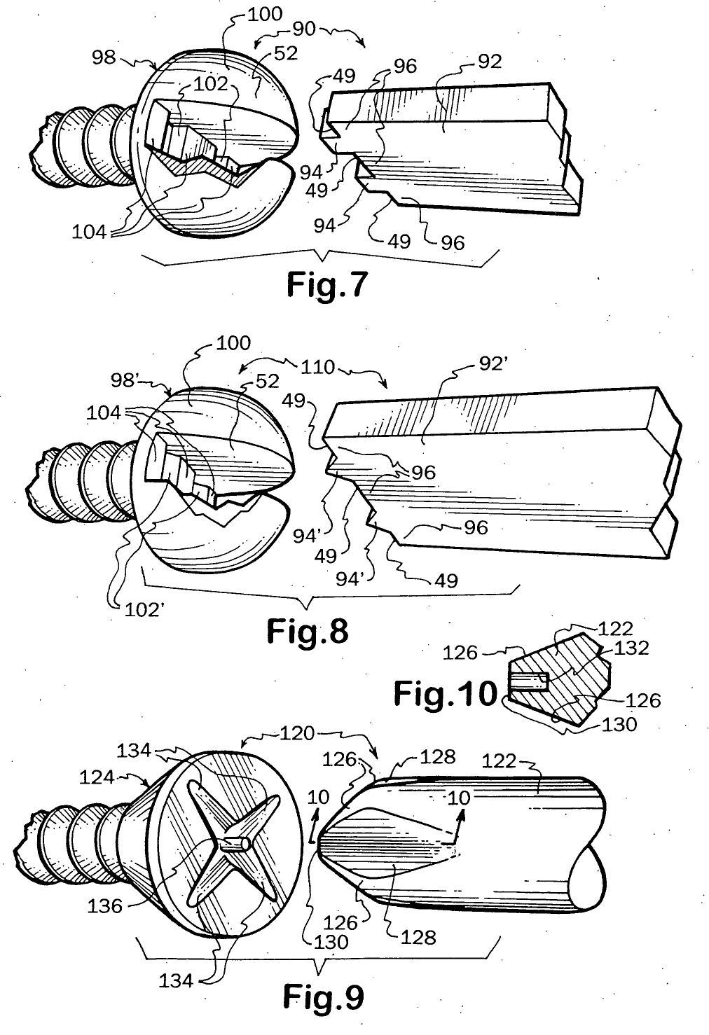

Reference is now made to FIG. 11, which illustrates a combination, generally designated 140, comprising a screwdriver blade or distal end 142 and a threaded fastener 144 comprising a rounded head 146 having a radial slot 52 therein. The combination 140 is substantially similar to the previously described combination 60 with two exceptions, i.e. the central stabilizing male projection 148 has a rounded stabilizing projection whereas the stabilizing projection 66 is pointed, and the central slot 52 of the fastener 144 comprises a rounded recess or slot 150 as opposed to an angular or V-shaped slot. Otherwise, the combination 140 is the same as combination 60 and has been so enumerated in FIG. 11 so that no further description of these elements is necessary for those skilled in the art. The operational aspects and the advantages of the combination 140 are the same as those described above in conjunction with the other embodiments of this invention.

Reference is now made to FIG. 12, which illustrates a further embodiment of this invention comprising a combination, generally designated 160. The combination 160 comprises a blade end or distal end of a screwdriver 162 and a threaded fastener 164. The threaded fastener 164 comprises, at its proximal edge, a donut-shape or annular male stabilizing segment 166 with a central annular cavity 168 disposes in the center thereof. Projecting in a proximal direction from the recess 168 is a generally rectangularly shaped torque receiving male member 170.

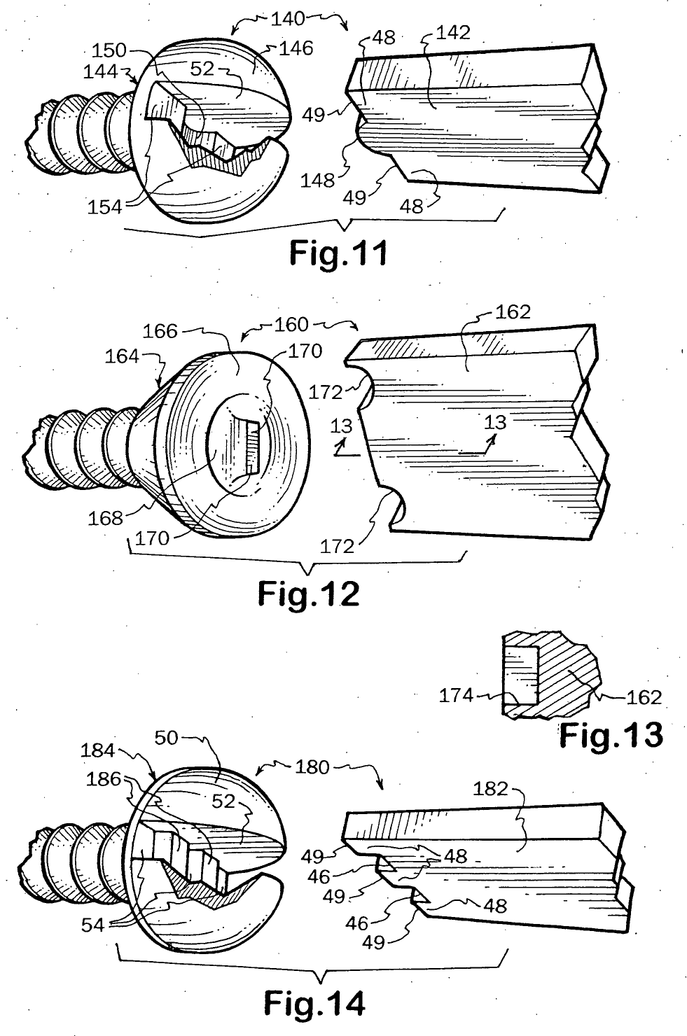

The screwdriver blade 162 comprises, at its distal edge, two spaced semi-circular female stabilizing female recesses 172, sized, shaped and located so as to contiguously fit over and engage the male annular stabilizer 166 of the threaded fastener 164, when the screwdriver blade 162 is properly placed in position to turn the threaded fastener 164. The distal edge of the screwdriver blade 162 also comprises a central rectangular blind bore 174. See FIG. 13. The blind rectangular bore 174 is located, sized and shaped so as to fit snugly and contiguously over a central male torque-receiving segment 170 located in recess 168. Thus, during operation, the screwdriver head 162 is positioned so that recesses 172 contiguously, as stabilizing segments, engage the annular stabilizer 166 of the threaded fastener 164, with the male torque receiving segment 170 fitting contiguously and snugly within the blind rectangular recess or cavity 174. Rotation of the threaded fastener 164, by reason of torque applied through the screwdriver blade 162, involves less torque and provides better stability between the screwdriver blade and the threaded fastener.

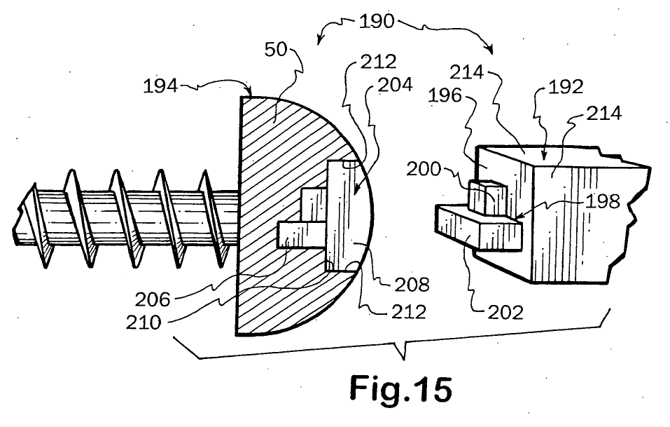

Reference is now made to the combination, generally designated 180, illustrated in FIG. 14. Combination 180 comprises the blade or distal end of a screwdriver 182 and a threaded fastener, generally designated 184. The combination 180 visually is similar to the combination 40, illustrated in FIG. 2. However, the screwdriver blade 182 provides three torque-applying segments 48, as opposed to one. The torque-applying segments 48 are essentially of equal width, spaced from each other by two rectangular slots or recesses 46, each having a width substantially the same as the width of each of the torque-applying segments 48. The fastener 184 comprises a spherical head 50, having a radially-directed, proximally-extending slot 52. The base .of slot is stepped, comprising lower base surfaces 54 and somewhat elevated rectangular projections 186. Elements 54 and 186 are sized, spaced and located so that surfaces 54 become contiguous with edges 49 and projections 186 become contiguous within slots 46, when the screwdriver blade 182 is fully inserted into slot 52. Thus, contiguous matching male/female stabilizing segments and contiguously matching male/female torque-applying segments are provided whereby turning of the fastener 184 using the screwdriver blade 182 requires less torque and provides better combination stability.

Reference is now made to FIG. 15, which illustrates a further combination, generally designated 190, comprising a screwdriver blade 192 and a threaded fastener 194. The screwdriver blade 192 comprises a blunt transverse distal edge 196 with a T-shaped male projection, generally designated 198, integral with and projecting therefrom in a distal direction. The T-shaped male projection comprises a stabilizing segment and includes two legs 200 and 202, which are disposed perpendicular to each other. The proximally-directed dimension of leg 200 is illustrated as being smaller than the proximal dimension of the leg 202. The T-shaped male stabilizing element 198 is located, sized and shaped so as to fit snugly into a stepped recess, generally designated 204, exposed at the proximal edge of the head 50 of the threaded fastener 194. The stepped recess 204 comprises a deep recess portion 206, which is T-shaped and located, sized and shaped so as to snugly receive, as a female stabilizing recess, the T-shaped male stabilizer 198. The recess 204 also comprises a shallow entry recess portion 204 in which the screwdriver blade 192 is snugly inserted such that distal edge 196 is contiguous with surface 210 of the shallow recess segment 208 and side edges 212 of the recess 208 are contiguous with side surfaces 214 of the screwdriver blade 192 during rotation of the fastener 194. It is, therefore, clear that, in combination, the screwdriver head and the fastener head comprise contiguously matching male/female stabilizing segments and contiguously matching male/female torque-applying segment such that rotation of the fastener requires less torque and there is greater stability between the screwdriver blade 192 and the fastener 194 during such rotation.

Any screw or bolt fastener head regardless of its configuration can be configurated with a receiving hole or slot to receive a screwdriver or power bit with a head configurated with a stabilizer made to fit and inserted into the hole or slot of the fastener head to achieve more control using less power to drive the fastener.

Conversely, the screw or bolt head of any fastener no matter how configurated can be made with a stabilizer in the screw or bolt head to receive a driver with a hole or slot designed to fit over and be received by the stabilizer configurated into the head of the fastener. This allows any existing fastener to be modified in their configuration so as to significantly improve torque and control with the fastener. This includes the fastener configuration known as the Torax by Textron.

Thus the patent consists of two new and significant points: 1) The stabilizer designed into the head of the fastener or the head of the screwdriver of bit and; 2) The hole or slot designed into the head of a fastener or the head of a driver designed to receive the stabilizer.

The invention may be embodied in other specific forms without departing from the spirit of essential characteristics thereof. The present embodiments therefore to be considered in all respects as illustrative and are not restrictive, the scope of the invention being indicated by the appended claims rather than by the foregoing description, and all changes which come within the meaning and range of equivalency of the claims are therefore intended to be embraced therein.

What is claimed is:

1-10. (canceled)

11. In combination:
a screwdriver with a distal end configured to engage a head of a fastener;
a threaded fastener with a head configurated to be operatively engaged by the distal end of the screwtip;
the screwdriver distal end and the fastener head comprising contiguously matching male/female position stabilizers which engage to materially resist proximal movement of the screwdriver distal end in respect to the fastener head during rotation of the fastener by force applied to the screwdriver and separate contiguous matching male/female torque-applying segments which engage to accommodate turning the fastener with less torque.

12. The combination of claim 11 wherein the position stabilizers comprise at least one male or female position stabilizer carried by the screwdriver distal end and at least one matching male or female position stabilizer carried at a slot in the fastener head.

13. The combination of claim 11 wherein the stabilizers comprise at least one female receptacle and at least one matching male extension.

14. The combination of claim 12 wherein the slotted fastener is selected from the group consisting of threaded screws and thread bolts.

15. The combination of claim 11 wherein the fastener head comprises a single slot.

16. The combination of claim 11 wherein the fastener head comprises phillip slots.

17. The combination of claim 11 wherein the fastener head is slotted comprising slot side walls and a base surface selected from the groups consisting of higher and lower portions and the screwdriver distal end comprises higher and lower segments which are sized, shaped and located to match the above-identified configurations of the fastener head.

18. The combination of claim 17 wherein the fastener head comprises higher portions which are selected from the group consisting of tapered, rectangular and circular ridges, flats and flanges.

19. The combination of claim 17 wherein the screwdriver distal end comprises higher and lower segments which selected from the group consisting of male and female rectangular and non-rectangular stabilizers.

20. The combination of claim 17 wherein the torque-applying portions and segments of the fastener distal end and screwdriver head comprise phillips-type configuration and the stabilizing portions and segments comprise at least one male cylindrical extension and at least one matching blind cylindrical bore.
